(19) United States
(12) Patent Application Publication
(10) Pub. No.: US 2026/0237247 A1
(43) Pub. Date: Aug. 13, 2026

(54) SYSTEMS AND METHODS FOR PERFORMING KEY FOB VEHICLE INFORMATION PROJECTION

(71) Applicants: Hyundai Motor Company, Seoul (KR); Kia Corporation, Seoul (KR)

(72) Inventor: Scott Agnew, Superior Township, MI (US)

(21) Appl. No.: 19/050,815

(22) Filed: Feb. 11, 2025

(51) Int. Cl. G07C 5/00

(52) U.S. Cl. CPC G07C 5/008

(57) ABSTRACT

Systems and methods of performing vehicle information projection using a vehicle remote key are provided. The method may comprise recording a snapshot of vehicle parameters using a computing device of a vehicle. The computing device may comprise a processor, a memory, and a transmitter. The method may comprise transmitting the snapshot to one or more remote keys associated with the vehicle, receiving the snapshot at a remote key of the one or more remote keys and storing the snapshot in the memory, activating a projector button on the remote key, and, when the projector button is activated, projecting a projection using a projector coupled to the remote key. The projection may comprise one or more pieces of information from the snapshot.

### BACKGROUND

### Technical Field

Embodiments of the present disclosure relate to systems and methods for performing vehicle key fob vehicle information projection.

### Background

Many newer vehicles come with key fobs configured to perform some functions of the vehicle such as, e.g., starting the engine, locking and/or unlocking the doors, opening the trunk, and turning an emergency alarm on and/or off.

A user may wish to know information and/or a status of their vehicle. For example, a user may wish to know how much fuel the vehicle has, what the odometer reading of the vehicle is, whether the vehicle has any warning signals (e.g., a Check Engine Light), and/or other suitable information (e.g., how to resolve any warnings). This may be especially true when the user is not near the vehicle nor has a vehicle-connected cell phone application.

However, the functions of a key fob are generally limited and do not provide users with status updates of the vehicle.

### SUMMARY

According to an object of the present disclosure, a method of performing vehicle information projection using a vehicle remote key is provided. The method may comprise obtaining information of predetermined vehicle parameters using a computing device of a vehicle. The computing device may comprise a processor, a memory, and a transmitter. The method may comprise information, receiving the information at a remote key of the one or more remote keys and storing the information in the memory, activating a projector button on the remote key, projecting a projection using a projector coupled to the remote key. The projection may comprise one or more pieces of information from the received information.

According to an exemplary embodiment, the method may comprise navigating, on the projection, between one or more pages of information from the received information.

According to an exemplary embodiment, each remote key may comprise one or more buttons configured to perform one or more functions, and the navigating may comprise selecting one or more pieces of information to be displayed using the one or more buttons.

According to an exemplary embodiment, the information may comprise one or more of the following, at the time of the obtaining: a vehicle identification number (VIN) of the vehicle; a fuel tank level of the vehicle; an odometer reading of the vehicle; an oil level percentage of the vehicle; one or more tire pressure values; a vehicle battery state of charge (SOC); a vehicle battery state of health (SOH); and an indication of which dashboard cluster lights, if any, were active.

According to an exemplary embodiment, the method may comprise determining whether the vehicle has been turned off. The obtaining the information of the vehicle parameters may occur when it has been determined that the vehicle has been turned off.

According to an exemplary embodiment, the projector may comprise one or more lasers.

According to an exemplary embodiment, the projecting the projection may comprise generating raster graphics using the one or more lasers.

According to an object of the present disclosure, a remote key is provided. The remote key may be a key fob may comprise a projector button, a memory, and a projector. The remote key (e.g. key fob) may be configured to receive information and store the information in the memory wherein the information comprises vehicle parameters of a vehicle. The projector button, when activated, may be configured to project a projection using the projector. The projection may comprise one or more pieces of information from the received information.

According to an exemplary embodiment, the remote key may be configured to enable a user to navigate, on the projection, between one or more pages of information from the received information.

According to an exemplary embodiment, the remote key may comprise one or more buttons configured to perform one or more functions. The navigating may comprise selecting one or more pieces of information to be displayed using the one or more buttons.

According to an exemplary embodiment, the information may comprise one or more of the following, at the time of being obtained: a VIN of the vehicle; a fuel tank level of the vehicle; an odometer reading of the vehicle; an oil level percentage of the vehicle; one or more tire pressure values; a vehicle battery SOC; a vehicle battery SOH; and an indication of which dashboard cluster lights, if any, were active.

According to an exemplary embodiment, the information of the vehicle parameters may comprise information that occurred when it was determined that the vehicle had been turned off.

According to an exemplary embodiment, the projector may comprise one or more lasers.

According to an exemplary embodiment, the projecting the projection may comprise generating raster graphics using the one or more lasers.

According to an object of the present disclosure, a system of performing vehicle information projection using a vehicle remote key is provided. The system may comprise a vehicle, comprising a computing device and one or more sensors. The computing device may comprise a processor, a memory, and a transmitter, and may be configured to obtain information of vehicle parameters of the vehicle, using the one or more sensors and transmit, using the transmitter, the information to one or more remote keys associated with the vehicle. The system may comprise the one or more remote keys. Each remote key of the one or more remote keys may comprise a projector button, a memory, and a projector. Each remote key of the one or more remote keys may be configured to receive the information. The projector button, when activated, may be configured to project a projection using the projector. The projection may comprise one or more pieces of information from the received information.

According to an exemplary embodiment, each remote key of the one or more remote keys may be configured to enable a user to navigate, on the projection, between one or more pages of information from the received information.

According to an exemplary embodiment, each remote key may comprise one or more buttons configured to perform one or more functions, and the navigating may comprise selecting one or more pieces of information to be displayed using the one or more buttons.

According to an exemplary embodiment, the information may comprise one or more of the following, at the time of being obtained: a VIN of the vehicle; a fuel tank level of the vehicle; an odometer reading of the vehicle; an oil level percentage of the vehicle; one or more tire pressure values; a vehicle battery SOC; a vehicle battery SOH; and an indication of which dashboard cluster lights, if any, were active.

According to an exemplary embodiment, the one or more sensors may be configured to determine whether the vehicle has been turned off, and the obtaining the information of the vehicle parameters may occur when it has been determined that the vehicle has been turned off.

According to an exemplary embodiment, the projector may comprise one or more lasers.

According to an exemplary embodiment, the projecting the projection may comprise generating raster graphics using the one or more lasers.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a system for performing vehicle remote key (key fob) vehicle information projection, according to an exemplary embodiment of the present disclosure.

FIG. 2 illustrates a remote key (key fob) configured for vehicle information projection, according to an exemplary embodiment of the present disclosure.

FIG. 3 illustrates a remote key (key fob) projecting a projection, according to an exemplary embodiment of the present disclosure.

FIG. 4 illustrates a remote key (key fob) projecting a projection, according to an exemplary embodiment of the present disclosure.

FIG. 5 illustrates a flowchart of an example method of performing vehicle remote key (key fob) vehicle information projection, according to an exemplary embodiment of the present disclosure.

FIG. 6 illustrates an example architecture of a vehicle, according to an exemplary embodiment of the present disclosure.

FIG. 7 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for performing vehicle key fob vehicle information projection are provided.

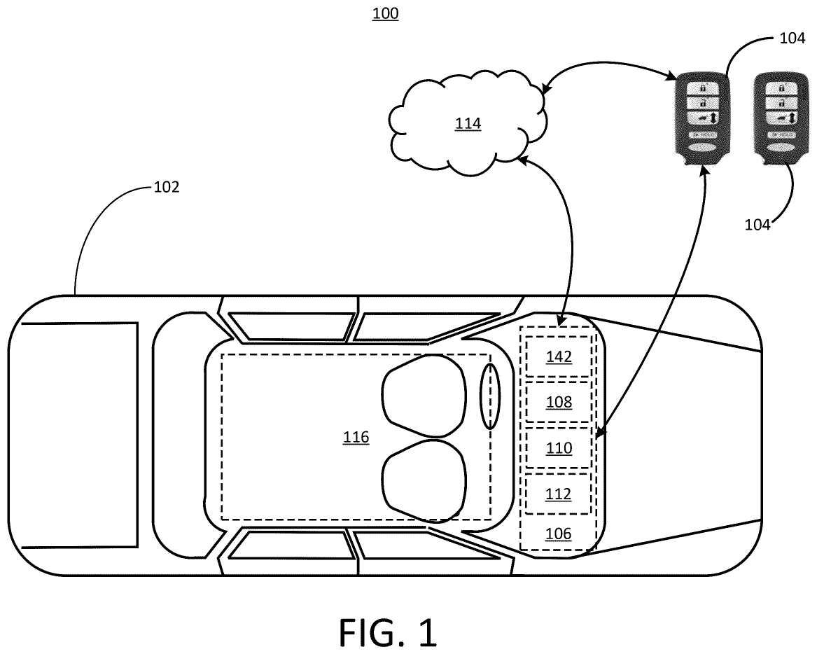

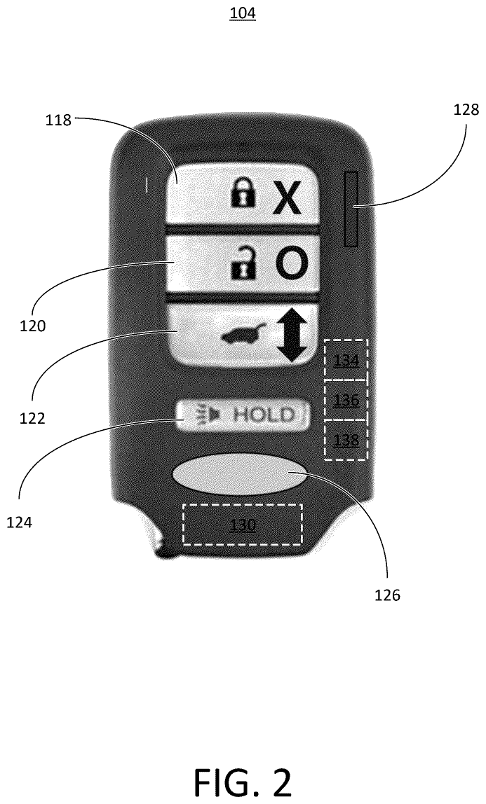

Referring now to FIGS. 1-2, a system 100 (FIG. 1) for performing vehicle remote key (key fob) 104 vehicle information projection, and the remote key (key fob) 104 (FIG. 2) are illustratively depicted, in accordance with an exemplary embodiment of the present disclosure.

According to an exemplary embodiment, the system 100 may comprise a vehicle 102 and one or more remote keys (key fobs) 104. The vehicle 102 may comprise an electric vehicle and/or other suitable vehicle.

According to an exemplary embodiment, the vehicle 102 may comprise a computing device 106. The computing device 106 may comprise a processor 108, a memory 110, and/or a user interface 112 (e.g., a graphical user interface). The computing device 106 may be configured to send and/or receive commands/data/input/etc. via one or more external systems via wired and/or wireless connection (e.g., via the cloud 114).

According to an exemplary embodiment, the key fob 104 may be configured to communicate with the vehicle 102 via the cloud 114, the one or more computing devices 106, and/or other suitable means.

The memory 110 may be configured to store programming instructions that, when executed by the processor 108, may be configured to cause the processor 108 to perform one or more tasks such as, e.g., recording information pertaining to the vehicle 102, transmitting the information to one or more key fobs 104 matched to the vehicle 102, and/or performing one or more other suitable tasks. According to an exemplary embodiment, the vehicle 102 may be configured to transmit the information to all nearby key fobs 104 each time the vehicle is turned off (e.g., key off).

According to an exemplary embodiment, the information pertaining to the vehicle 102 may comprise the vehicle's 102 vehicle identification number (VIN), the vehicle's 102 fuel tank level (e.g., gallons, percentage, miles to empty, etc.), the odometer reading, the oil level percentage, the tire pressure value(s), the key fob battery level (e.g., battery percentage), a vehicle battery 116 state of charge (SOC) and/or state of health (SOH), one or more dashboard cluster lights that may be active, and/or other suitable information.

According to an exemplary embodiment, the key fob 104 may comprise one or more buttons, each button configured to perform one or more functions. According to an exemplary embodiment, the one or more buttons may be configured to cause the vehicle 102 and/or the key fob 104 to perform one or more functions. For example, the one or more buttons may comprise a door lock button 118, a door unlock button 120, a trunk open button 122, an alarm button 124, a projector button 126, and/or other suitable buttons.

According to an exemplary embodiment, the key fob 104 may comprise a projector 128 configured to project information to be viewable by the user. The projector 128 may be positioned on the back of the key fob 104 to project graphics away from the user. It is noted, however, that the projector 128 may be positioned at any suitable location on the key fob 104.

According to an exemplary embodiment, the key fob 104 may comprise a data storage component 130 (e.g., flash memory and/or other suitable data storage) configured to store the information pertaining to the vehicle 102. According to an exemplary embodiment, the projector 128 may be configured to project some or all of the information pertaining to the vehicle 102 when the projector button 126 is pressed/activation, enabling the user to check/review recent vehicle 102 information even when the user is away from the vehicle 102.

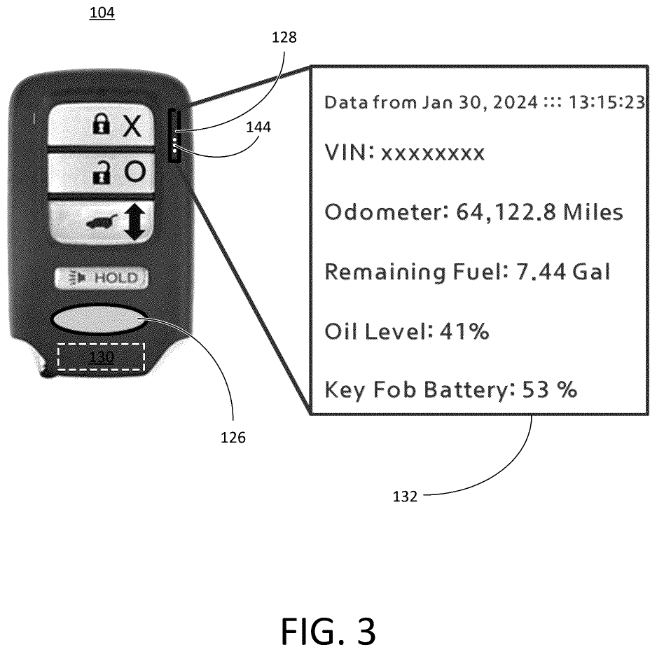

According to an exemplary embodiment, the projector 128 may be configured to form a projection 132 onto a surface. The projection 132 may comprise some or all of the information pertaining to the vehicle 102 and/or pertaining to the key fob 104. For example, as shown in FIG. 3, the projection 132 may comprise the date/time, the vehicle's 102 VIN, the odometer reading, the remaining fuel, the oil level, the key fob 104 battery level (of a battery 134 of the key fob 104), and/or other suitable information. According to an exemplary embodiment, the projector 128 may be configured to project the projection 132 onto a flat surface (or other suitable surface) when the key fob 104 is held up to the surface (e.g., a desk, wall, etc.).

According to an exemplary embodiment, the key fob 104 may be configured to enable the user to navigate between two or more pages of information pertaining to the vehicle 102. For example, upon pressing/activation of the projector button 126, the projector 128 may project a main page (as shown, e.g., in FIG. 3).

According to an exemplary embodiment, the user may navigate between the two or more pages using one or more buttons of the key fob 104. For example, the key fob 104 may comprise one or more buttons dedicated to performing one or more projection functions (e.g., switching between pages, confirming a selection/page, cancelling a selection/page, etc.) and/or may be configured to use existing buttons (e.g., the door lock button 118, the door unlock button 120, the trunk open button 122, the alarm button 124, etc.) to perform the one or more projection functions. For example, the key fob 104 may be configured such that, while the projector button 126 is pressed/active, the existing buttons may have an altered functionality. For example, while the projector button 126 is pressed/active, the door lock button 118 may have a cancel/back function, the door unlock button 120 may have a confirmation/select function, and the trunk open button 122 may have a next/toggle function. It is noted, however, that buttons may have different suitable altered functions while maintaining the spirit and functionality of the present disclosure. According to an exemplary embodiment, the existing buttons may comprise one or more indicators/icons present on the buttons to signify the altered function(s).

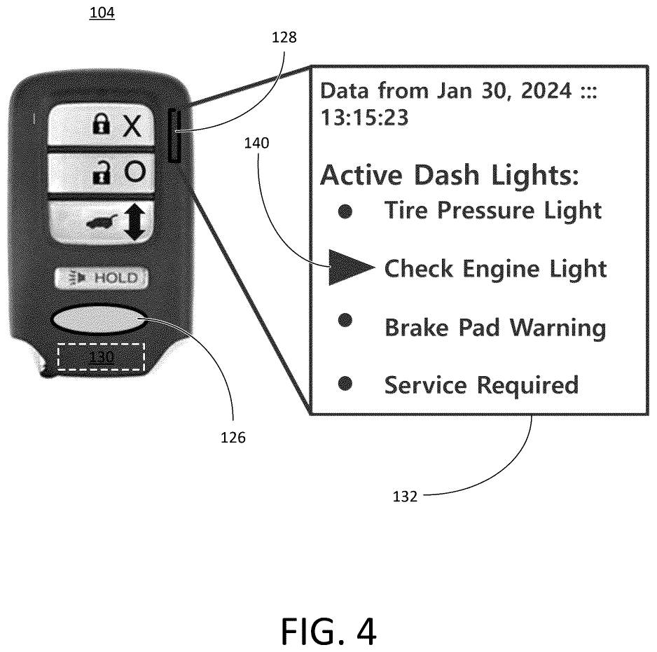

According to an exemplary embodiment, upon pressing the toggle function button (e.g., the trunk open button 122) or the select function button (e.g., the door unlock button 120), the projection 132 may display a Dashboard Light Page (as shown, e.g., in FIG. 4), which shows/indicates which dashboard lights (if any) were active when the vehicle 102 was most recently turned off. According to an exemplary embodiment, when on the dashboard light page, pressing the toggle function button (e.g., the trunk open button 122) may move a cursor 140 to highlight each active dashboard light (e.g., tire pressure light, check engine light, brake par warning light, service required light, and/or other suitable dashboard light). According to an exemplary embodiment, when the cursor 140 is on the desired dashboard light, pressing the select function button (e.g., the door unlock button 120) may change the graphics (i.e., the projection 132) to describe the highlighted dashboard light, any corresponding user manual pages, any recommended steps to resolve the issue associated with the highlighted dashboard light, and/or any other suitable information. According to an exemplary embodiment, pressing the cancel/back function butting (e.g., the door lock button 118) may revert the projection 132 back to the main page.

According to an exemplary embodiment, the projector button 126 may be configured to be active when it is actively being pressed and is inactive when not being pressed. According another exemplary embodiment, the projector button 126 may be configured to be active after it is pressed and remain active until it is pressed again, at which point it will be inactive. According to another exemplary embodiment, the projector button 126 may be configured to remain active for a set time after being pressed and switched to inactive when the set time expires.

According to an exemplary embodiment, the key fob 104 may comprise a processor 136 configured to perform the one or more functions of the key fob 104 derived from the one or more buttons. According to an exemplary embodiment, the key fob 104 may comprise a transceiver 138 configured to communicate (e.g., send information and/or receive information) with the vehicle 102.

According to an exemplary embodiment, the projector 128 may be any suitable projector configured to fit within and/or on the key fob 104 and configured to project the projection 132 onto a surface. According to an exemplary embodiment, the projector 128 may comprise a micro-electro-mechanical system (MEMS) micromirror, a laser beam scanner (LBS), a magnifying lens and/or similar device, and/or other suitable device. According to an exemplary embodiment, the projector 128 may comprise one or more lasers 144.

According to an exemplary embodiment, the MEMS may be configured to use electrical energy to twist one or more mirrors along one or more axes, and may use one mirror with a biaxial sweep or two mirrors with one axial sweep each. This actuation (twist) method may be electrostatic, electromagnetic, or piezoelectric.

According to an exemplary embodiment, an LBS may be used/implemented by, for a one-mirror example, rapidly sweeping the mirror's X and Y axis angles, and shining a laser on it, projecting raster graphics (wherein a laser goes over each spot in a grid pattern and, at each point in the grid pattern, the last is either on or off) and, for a two-mirror example, using three lasers (R, G, B) to generate full color images using laser raster graphics. According to an exemplary embodiment, the projector 128 may comprise a magnifying lens to increase a size of the projection 132.

According to an exemplary embodiment, the key fob 104 may be configured to detect the presence of one or more objects moving against the projection 132. In such a scenario, the key fob 104 may be configured such that a user may navigate between pages of information by pressing the projected arrow icons on the projection 132 rather than (or in addition to) pressing one or more buttons on the key fob 104. The key fob 104 could then detect this input in a way similar to how projection keyboards detect input, and shift the page accordingly.

According to an exemplary embodiment, when the key fob 104 may comprise an accelerometer or orientation sensor installed thereon or therein. In such a scenario, data from the sensor may be used to determine when the key fob 104 is laying flat on a table (as opposed to being held by a user). When the projector 128 is activated and the key fob 104 is determined to be laying flat on a table, then a projector MEMS system may be configured to use an alternative set of mirror X and Y positions to form the projection 132, enabling the projector 128 to project onto the flat surface (on which the key fob 104 is laying) with better visual clarity.

The system 100 is configured to quickly provide vehicle 102 information to users, improving upon phone applications due to its increase in speed and simplicity. Standard key fobs generally communicate with vehicles using radio waves, wherein the key fob sends an encoded signal and the vehicle interprets that signal into a command such as, e.g., locking/unlocking the doors, wherein the key fob sends a signal to the vehicle during key fob/vehicle communication. Contrary to this, according to an exemplary embodiment of the present disclosure, the vehicle 102 sends communications to the key fob 104 and the key fob 104 is configured to receive these communications.

According to an exemplary embodiment, at every key off event (when the vehicle 102 is turned off), a transmitter/transceiver 142 in electronic communication with the vehicle 102 (e.g., embedded in the vehicle 102 cabin and/or other suitable location on or within the vehicle 102) may be configured to send/transmit encoded information to all nearby compatible key fobs 104 (i.e., any key fob 104 that is normally able to lock/unlock the vehicle 102). The encoded information captures a snapshot of key vehicle 102 parameters, including, but not limited to, the VIN, the vehicle's 102 fuel tank level, the odometer reading, the oil level percentage, the tire pressure value(s), the key fob 104 battery level, a vehicle battery 116 SOC and/or SOH, one or more dashboard cluster lights that may be active, and/or other suitable information. The key fob(s) 104 may be configured, using the processor 136, to decode the information and store it in the data storage component 130. These parameters may be expressed as simple floats, strings, etc., so that only a small amount of flash memory is needed. It is noted that, while radio wave communication is described here due to key fobs and vehicles already communicating in this manner, pther communication methods (e.g., Bluetooth, IR, etc.) may be incorporated while maintaining the spirit and functionality of the present disclosure.

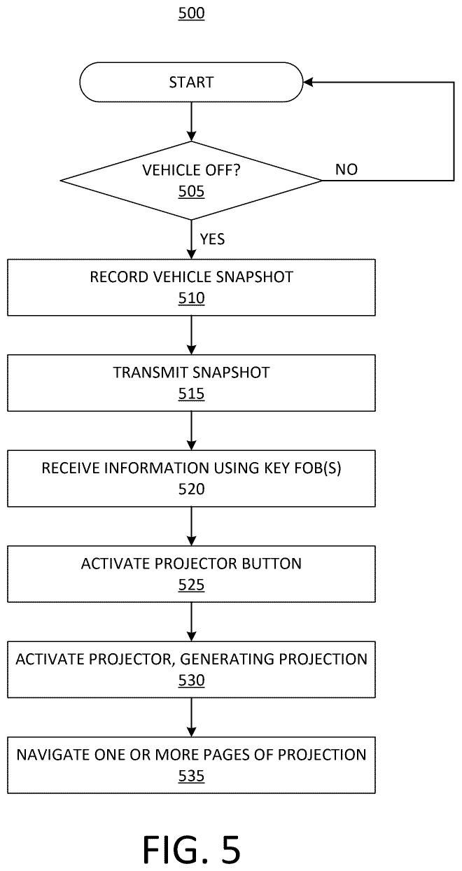

Referring now to FIG. 5, a flowchart of a method 500 of performing vehicle key fob vehicle information projection is illustratively depicted, in accordance with an exemplary embodiment of the present disclosure.

At 505, a computing device of a vehicle determines whether the vehicle has been turned off. When the vehicle has been turned off, then, at 510, a snapshot of key vehicle parameters is recorded by a computing device of the vehicle. The snapshot may include, but is not limited to, the VIN, the vehicle's fuel tank level, the odometer reading, the oil level percentage, the tire pressure value(s), a vehicle battery SOC and/or SOH, a list of one or more dashboard cluster lights that may be active, and/or other suitable information. The information in the snapshot may be recorded using one or more sensors. This snapshot, at 515, may be transmitted to one or more key fobs associated with the vehicle. The one or more key fobs, at 520, receive the information and store the information on a data store.

At 525, a user may activate a projector button on a key fob by suitable means (e.g., pressing the projector button. Activating the projector button causes the projector of the key fob, at 530, to activate, projecting a projection. The projection may comprise some or all (e.g., one or more pieces of information) of the information pertaining to the vehicle and/or information pertaining to the key fob in the snapshot such as, e.g., the key fob's battery level. For example, the projection may comprise the date/time, the vehicle's VIN, the odometer reading, the remaining fuel, the oil level, the key fob battery level (of a battery of the key fob), and/or other suitable information. According to an exemplary embodiment, the projector may be configured to project the projection onto a flat surface (or other suitable surface) when the key fob is held up to the surface (e.g., a desk, wall, etc.).

At 535, the user, using one or more buttons of the key fob, may navigate, on the projection, between two or more pages of information pertaining to the vehicle. For example, according to an exemplary embodiment, upon pressing the toggle function button (e.g., the trunk open button) or the select function button (e.g., the door unlock button), the projection may display a Dashboard Light Page, which shows/indicates which dashboard lights (if any) were active when the vehicle was most recently turned off. According to an exemplary embodiment, when on the dashboard light page, pressing the toggle function button (e.g., the trunk open button) may move a cursor to highlight each active dashboard light (e.g., tire pressure light, check engine light, brake par warning light, service required light, and/or other suitable dashboard light). According to an exemplary embodiment, when the cursor is on the desired dashboard light, pressing the select function button (e.g., the door unlock button) may change the graphics (i.e., the projection) to describe the highlighted dashboard light, any corresponding user manual pages, any recommended steps to resolve the issue associated with the highlighted dashboard light, and/or any other suitable information. According to an exemplary embodiment, pressing the cancel/back function butting (e.g., the door lock button) may revert the projection back to the main page.

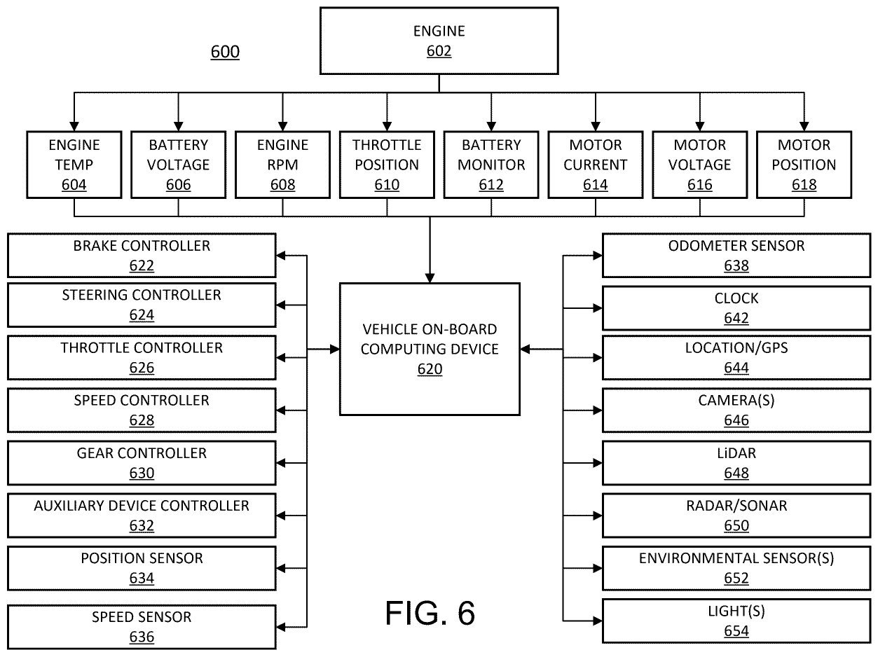

Referring now to FIG. 6, an example vehicle system architecture 600 for a vehicle is provided, in accordance with an exemplary embodiment of the present disclosure. The following discussion of vehicle system architecture 600 is sufficient for understanding one or more components of vehicle 100.

As shown in FIG. 6, the vehicle system architecture 600 may comprise an engine, motor or propulsive device 602 and various sensors 604-618 for measuring various parameters of the vehicle system architecture 600, such as, but not limited to, those of the vehicle snapshot described above. In gas-powered or hybrid vehicles having a fuel-powered engine, the sensors 604-618 may comprise, for example, an engine temperature sensor 604, a battery voltage sensor 606, an engine Rotations Per Minute (RPM) sensor 608, and/or a throttle position sensor 610. If the vehicle is an electric or hybrid vehicle, then the vehicle may comprise an electric motor, and accordingly may comprise sensors such as a battery monitoring system 612 (to measure current, voltage and/or temperature of the battery), motor current 614 and voltage 616 sensors, and motor position sensors such as resolvers and encoders 618.

Operational parameter sensors that are common to both types of vehicles may comprise, for example: a position sensor 634 such as an accelerometer, gyroscope and/or inertial measurement unit; a speed sensor 636; and/or an odometer sensor 638. The vehicle system architecture 600 also may comprise a clock 642 that the system uses to determine vehicle time and/or date during operation. The clock 642 may be encoded into the vehicle on-board computing device 620, it may be a separate device, or multiple clocks may be available.

The vehicle system architecture 600 may comprise various sensors that operate to gather information about the environment in which the vehicle is traveling. These sensors may comprise, for example: a location sensor 644 (for example, a Global Positioning System (GPS) device); object detection sensors such as one or more cameras 646; a LiDAR sensor system 648; and/or a radar and/or a sonar system 650. The sensors may comprise environmental sensors 652 such as, e.g., a humidity sensor, a precipitation sensor, a light sensor, and/or ambient temperature sensor. The object detection sensors may be configured to enable the vehicle system architecture 600 to detect objects that are within a given distance range of the vehicle in any direction, while the environmental sensors 652 may be configured to collect data about environmental conditions within the vehicle's area of travel. According to an exemplary embodiment, the vehicle system architecture 600 may comprise one or more lights 654 (e.g., headlights, flood lights, flashlights, etc.).

During operations, information may be communicated from the sensors to an on-board computing device 620 (e.g., computing device 106, processor 136, memory 130, and computing device 700). The on-board computing device 620 may be configured to analyze the data captured by the sensors and/or data received from data providers and may be configured to optionally control operations of the vehicle system architecture 600 based on results of the analysis. For example, the on-board computing device 620 may be configured to control: braking via a brake controller 622; direction via a steering controller 624; speed and acceleration via a throttle controller 626 (in a gas-powered vehicle) or a motor speed controller 628 (such as a current level controller in an electric vehicle); a differential gear controller 630 (in vehicles with transmissions); and/or other controllers. The brake controller 622 may comprise a pedal effort sensor, pedal effort sensor, and/or simulator temperature sensor, as described herein.

Geographic location information may be communicated from the location sensor 644 to the on-board computing device 620, which may then access a map of the environment that corresponds to the location information to determine known fixed features of the environment such as streets, buildings, stop signs and/or stop/go signals. Captured images from the cameras 646 and/or object detection information captured from sensors such as LiDAR 648 may be communicated from those sensors to the on-board computing device 620. The object detection information and/or captured images may be processed by the on-board computing device 620 to detect objects in proximity to the vehicle. Any known or to be known technique for making an object detection based on sensor data and/or captured images may be used in the embodiments disclosed in this document.

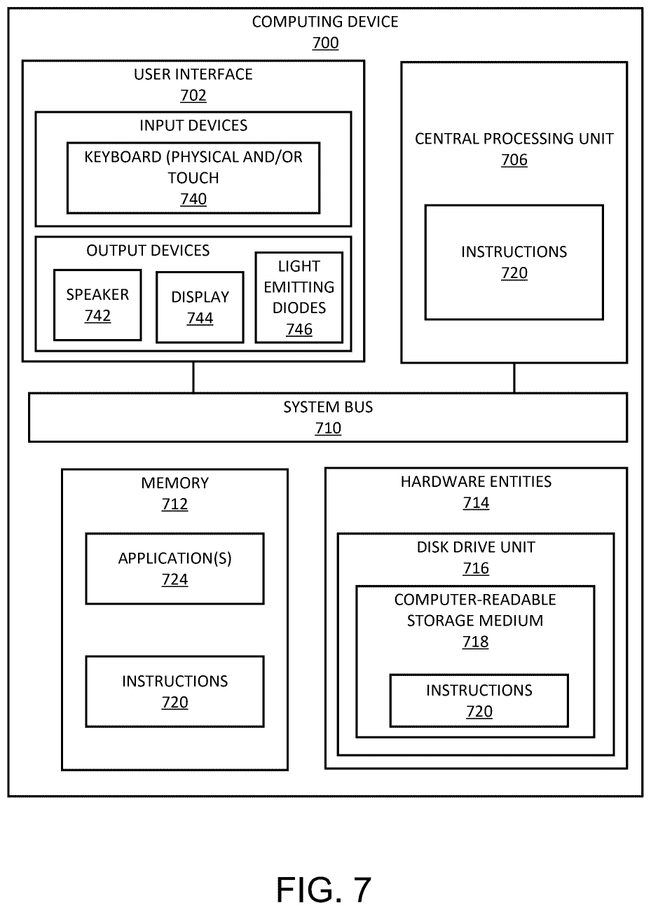

Referring now to FIG. 7, an illustration of an example architecture for a computing device 700 is provided. According to an exemplary embodiment, one or more functions of the present disclosure may be implemented by a computing device such as, e.g., computing device 700 or a computing device similar to computing device 700. Computing device 700 may be a quantum computer, a classical computer, and/or have one or more components configured to perform one or more quantum and/or classical computing functions. Computing device 106, processor 136, memory 130, and/or computing device 620 may be an example of computing device 700 and/or may comprise one or more components of computing device 700.

The hardware architecture of FIG. 7 represents one example implementation of a representative computing device configured to implement at least a portion of the systems/devices (e.g., vehicle 100 and key fob 104) and method(s)/control logic(s) (e.g., method 500) described herein.

Some or all components of the computing device 700 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 7, the computing device 700 may comprise a user interface 702 (e.g., a graphical user interface), a Central Processing Unit (“CPU”) 706, a system bus 710, a memory 712 connected to and accessible by other portions of computing device 700 through system bus 710, and hardware entities 714 connected to system bus 710. The user interface may comprise input devices and output devices, which may be configured to facilitate user-software interactions for controlling operations of the computing device 700. The input devices may comprise, but are not limited to, a physical and/or touch keyboard 740. The input devices may be connected to the computing device 700 via a wired or wireless connection (e.g., a Bluetooth® connection). The output devices may comprise, but are not limited to, a speaker 742, a display 744, and/or light emitting diodes 746.

At least some of the hardware entities 714 may be configured to perform actions involving access to and use of memory 712, which may be a Random Access Memory (RAM), a disk driver and/or a Compact Disc Read Only Memory (CD-ROM), among other suitable memory types. Hardware entities 714 may comprise a disk drive unit 716 comprising a computer-readable storage medium 718 on which may be stored one or more sets of instructions 720 (e.g., programming instructions such as, but not limited to, software code) configured to implement one or more of the methodologies, procedures, or functions described herein. The instructions 720 may also reside, completely or at least partially, within the memory 712 and/or within the CPU 706 during execution thereof by the computing device 700.

The memory 712 and the CPU 706 may also constitute machine-readable media. The term “machine-readable media”, as used here, refers to a single medium or multiple media (e.g., a centralized or distributed database, and/or associated caches and servers) that store the one or more sets of instructions 720. The term “machine-readable media”, as used here, also refers to any medium that is capable of storing, encoding, or carrying a set of instructions 720 for execution by the computing device 700 and that cause the computing device 700 to perform any one or more of the methodologies of the present disclosure. According to various embodiments, one or more computer applications 724 may be stored on the memory 712.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A method of performing vehicle information projection using a vehicle remote key, comprising:
obtaining information of predetermined vehicle parameters using a computing device of a vehicle,
wherein the computing device comprises a processor, a memory, and a transmitter;
transmitting the information to one or more remote keys associated with the vehicle;
receiving the information at a remote key of the one or more remote keys and storing the information in the memory;
activating a projector button on the remote key; and
when the projector button is activated, projecting a projection using a projector coupled to the remote key,
wherein the projection comprises one or more pieces of information from the received information.

2. The method of claim 1, further comprising navigating, on the projection, between one or more pages of information from the received information.

3. The method of claim 2, wherein:
each remote key comprises one or more buttons configured to perform one or more functions, and
the navigating comprises selecting one or more pieces of information to be displayed using the one or more buttons.

4. The method of claim 1, wherein the information comprises one or more of the following, at the time of the obtaining:
a vehicle identification number (VIN) of the vehicle;
a fuel tank level of the vehicle;
an odometer reading of the vehicle;
an oil level percentage of the vehicle;
one or more tire pressure values;
a vehicle battery state of charge (SOC);
a vehicle battery state of health (SOH); and
an indication of which dashboard cluster lights, if any, were active.

5. The method of claim 1, further comprising determining whether the vehicle has been turned off, and
wherein the obtaining the information of the vehicle parameters occurs when it has been determined that the vehicle has been turned off.

6. The method of claim 1, wherein:
the projector comprises one or more lasers, and
the projecting the projection comprises generating raster graphics using the one or more lasers.

7. A remote key, comprising:
a projector button;
a memory; and
a projector,
wherein the remote key is configured to:
receive information and store the information in the memory wherein the information comprises vehicle parameters of a vehicle,
the projector button, when activated, is configured to project a projection using the projector, and
the projection comprises one or more pieces of information from the received information.

8. The remote key of claim 7, wherein the remote key is configured to enable a user to navigate, on the projection, between one or more pages of information from the received information.

9. The remote key of claim 8, further comprising one or more buttons configured to perform one or more functions,
wherein the navigating comprises selecting one or more pieces of information to be displayed using the one or more buttons.

10. The remote key of claim 7, wherein the information comprises one or more of the following, at the time of being obtained:
a vehicle identification number (VIN) of the vehicle;
a fuel tank level of the vehicle;
an odometer reading of the vehicle;
an oil level percentage of the vehicle;
one or more tire pressure values;
a vehicle battery state of charge (SOC);
a vehicle battery state of health (SOH); and
an indication of which dashboard cluster lights, if any, were active.

11. The remote key of claim 7, wherein the information of the vehicle parameters comprises information that occurred when it was determined that the vehicle had been turned off.

12. The remote key of claim 7, wherein the projector comprises one or more lasers.

13. The remote key of claim 12, wherein the projecting the projection comprises generating raster graphics using the one or more lasers.

14. A system of performing vehicle information projection using a vehicle remote key, comprising:
a vehicle, comprising a computing device and one or more sensors,
wherein the computing device comprises a processor, a memory, and a transmitter, and is configured to:
obtain information of vehicle parameters of the vehicle, using the one or more sensors; and
transmit, using the transmitter, the information to one or more remote keys associated with the vehicle; and
the one or more remote keys,
wherein:
each remote key of the one or more remote keys comprises:
a projector button;
a memory; and
a projector,
each remote key of the one or more remote keys is configured to receive the information;
the projector button, when activated, is configured to project a projection using the projector, and
the projection comprises one or more pieces of information from the received information.

15. The system of claim 14, wherein each remote key of the one or more remote keys is configured to enable a user to navigate, on the projection, between one or more pages of information from the received information.

16. The system of claim 15, wherein:
each remote key comprises one or more buttons configured to perform one or more functions, and
the navigating comprises selecting one or more pieces of information to be displayed using the one or more buttons.

17. The system of claim 14, wherein the information comprises one or more of the following, at the time of being obtained:
a vehicle identification number (VIN) of the vehicle;
a fuel tank level of the vehicle;
an odometer reading of the vehicle;
an oil level percentage of the vehicle;
one or more tire pressure values;
a vehicle battery state of charge (SOC);
a vehicle battery state of health (SOH); and
an indication of which dashboard cluster lights, if any, were active.

18. The system of claim 14, wherein:
the one or more sensors are configured to determine whether the vehicle has been turned off, and
the obtaining the information of the vehicle parameters occurs when it has been determined that the vehicle has been turned off.

19. The system of claim 14, wherein the projector comprises one or more lasers.

20. The system of claim 19, wherein the projecting the projection comprises generating raster graphics using the one or more lasers.
